(19) United States
(12) Patent Application Publication
(10) Pub. No.: US 2026/0217200 A1
(43) Pub. Date: Jul. 30, 2026

(54) Camera device for a vehicle, vehicle, method, computer program and data carrier

(71) Applicant: AUMOVIO Autonomous Mobility Germany GmbH, Ingolstadt (DE)

(72) Inventor: Stefan Christmann, Geislingen an der Steige (DE)

(73) Assignee: AUMOVIO Autonomous Mobility Germany GmbH, Ingolstadt (DE)

(21) Appl. No.: 19/456,316

(22) Filed: Jan. 22, 2026

(30) Foreign Application Priority Data
Jan. 24, 2025 (DE) 10 2025 102 571.1

(51) Int. Cl. B60R 11/04; H04N 23/57; H04N 23/69; H04N 23/695

(52) U.S. Cl. CPC B60R 11/04; H04N 23/57; H04N 23/69; H04N 23/695

(57) ABSTRACT

A vehicle camera device including at least one camera and a connected control device to the camera. The camera has an image sensor, a lens, and at least one actuator to move the image sensor relative to the lens. The generated camera images provide at least one driver assistance vehicle function. One or more operating specifications for operating the at least one camera and an item of authorization information are stored in the control device. The operating specifications contain different image sensor actuation before and/or during generation of at least one camera image. The authorization information for at least part of the operating specifications describes whether these are each currently available for generating a camera image for the driver assistance function. The camera images for the at least one driver assistance function can only be generated based on at least one operating specification of the available multiple operating specifications.

### CROSS REFERENCE TO RELATED APPLICATIONS

This application claims priority to German Application No. 10 2025 102 571.1, filed Jan. 24, 2025, the contents of such application being incorporated by reference herein.

### FIELD OF THE INVENTION

The invention relates to a camera device for a vehicle comprising at least one camera and a control device connected to the camera, wherein the at least one camera has an image sensor, a lens arrangement comprising at least one lens, and at least one actuator by way of which the image sensor can be moved relative to the lens arrangement, and wherein camera images generated with the at least one camera can be used for providing at least one driver assistance function of the vehicle. The invention further relates to a vehicle and to a method for operating a camera device, to a computer program and to a data carrier.

### BACKGROUND OF THE INVENTION

Cameras are used in modern vehicles, for example to detect objects in the vehicle environment. In this case, individual cameras can capture, for example, part of an interior of the vehicle or a region in front of the vehicle, next to the vehicle, behind the vehicle and/or under the vehicle. The images generated by one or more of the cameras and/or a view of the environment derived from or composed of these images can be displayed to a driver of the vehicle as part of a driver assistance function, for example to facilitate maneuvering in a confined space or a parking procedure. Furthermore, such camera images can also be processed with the aid of a computing device in order to provide further types of driver assistance functions based on the vehicle environment.

For the purpose of recording images, cameras generally comprise an image sensor, by means of which light or electromagnetic radiation in the visible spectrum and/or electromagnetic radiation in the infrared spectrum can be detected. In order to be able to move the image sensor relative to other components of the camera, it is known for some types of camera to couple the image sensor to an actuator in order to allow different functions and/or improvements in image recording. Various approaches are known from the prior art for this purpose.

US 2021/0354979 A1, incorporated herein by reference, describes a camera with an image sensor which can be adjusted relative to a lens of the camera by means of an actuator. The image sensor can, in this case, be moved along the optical axis of the camera in order to achieve focusing depending on a temperature.

WO 2022/115932 A1, incorporated herein by reference, describes an actuator for the image sensor of a camera which enables a movement of the image sensor with up to five degrees of freedom. An autofocus function and an increase in the resolution of the image sensor can be achieved with the aid of the actuator.

The mobility of an image sensor of a vehicle camera via an actuator makes it possible to influence the camera images or the representation of a vehicle environment in the camera images. This also has an impact on the function of driver assistance systems of the vehicle, which reproduce the camera images and/or implement further functions, for example autonomous or semiautonomous driving maneuvers or the like, on the basis of the camera images.

Since the expectations and/or the requirements of such a driver assistance system can change in the course of a vehicle lifetime, it is desirable that the properties and/or the performance of a camera device used to provide the driver assistance system can also be improved after the production of a vehicle comprising the camera device, and/or can be adapted to the current needs of a user.

### SUMMARY OF THE INVENTION

An aspect of the invention is therefore based on specifying an improved camera device which makes it possible, in particular, to modify the generation of camera images by means of the camera device after production of the camera system.

To achieve this, in a camera device of the type mentioned at the outset, it is provided according to an aspect of the invention that multiple operating specifications for operating the at least one camera and an item of authorization information are stored in the control device, wherein the operating specifications each contain different actuation of the image sensor by means of the at least one actuator before and/or during the generation of at least one camera image by the at least one camera, and the authorization information for at least some of the operating specifications describes whether these are respectively currently available for generating a camera image for providing the at least one driver assistance function, wherein the camera images for the at least one driver assistance function can only be generated on the basis of at least one operating specification of the multiple operating specifications described as currently available.

The camera device comprises one or more cameras and a control device connected thereto. The cameras can be, in particular, cameras which each serve for detecting at least a part of the vehicle environment. For example, the at least one camera can be a front camera, a side camera and/or a rear view camera of a vehicle or a camera provided for a corresponding arrangement on a vehicle. The one or more cameras of the camera device each comprise an image sensor, a lens arrangement comprising at least one lens, and at least one actuator by way of which the image sensor can be moved relative to the lens arrangement. The image sensor can be moved into different arrangement positions by means of the actuator before and/or during the generation of a camera image. In other words, by means of the actuator, the image sensor can be moved relative to the lens arrangement or relative to a projection image of the vehicle environment that is produced by the lens arrangement, such that camera images can be recorded in different relative arrangements between the lens arrangement and the image sensor. The movements of the image sensor may in this case take place at different speeds and/or in different motion sequences or sequences of movements.

The control device of the camera device may for example be a controller of a vehicle and/or comprise a processor, a microcontroller or some other type of computing device. The control device also comprises an, in particular, non-volatile memory device in which information such as computer programs, control commands for actuating components of the at least one camera and the like can be stored.

One or more operating specifications for operating the at least one camera are stored in the control device, in particular in the memory device of the control device, wherein the operating specifications each contain different actuation of the image sensor by means of the at least one actuator before and/or during the generation of at least one camera image by the at least one camera. The operating specifications are or contain, for example, a program or a sequence of control instructions or a movement pattern which specify how the control device is to activate the camera and its components, in particular the actuator and the image sensor, in order to record one or more camera images. The operating specifications may also contain further instructions or commands which describe how the control device can generate the camera image from image data generated with the aid of the image sensor, for example by combining multiple partial images, on the basis of image information generated at different arrangement positions of the image sensor, or the like.

The actuator is preferably a microelectric-mechanical system (MEMS) or a MEMS actuator. The actuator permits movement of the image sensor relative to the lens arrangement along one or more degrees of freedom. The degrees of freedom can be translational degrees of freedom, in particular along a direction of the optical axis of the camera and along two directions that are orthogonal to one another and orthogonal to the optical axis. The image sensor of the camera can be moved via the actuator of the camera, i.e., in particular along the optical axis of the camera and within the image plane of the camera, that is to say in particular within a plane orthogonal to the optical axis of the camera. It is also possible that one or a plurality of the degrees of freedom are rotational degrees of freedom, which in particular permit rotation about the optical axis and/or about one or more spatial directions orthogonal to the optical axis of the camera.

In particular, the orientation of the image sensor with respect to the lens arrangement and with respect to a projection image of a vehicle environment produced by the lens device can be set depending on the available degrees of freedom for the movement of the image sensor relative to the lens arrangement. This makes it possible, for example, to at least partially compensate for different forms of misalignment between the image sensor and at least one further component of the camera and/or to influence the image production by the lens arrangement on the image sensor.

In addition, authorization information is stored in the control device which describes, for at least some of the operating specifications, whether or not each of these are currently available for the generation of a camera image for providing the at least one driver assistance function. The authorization information is in particular changeable information, that is to say the authorization information stored in the control device describes a changeable assignment of authorization information, in particular to multiple operating specifications stored in the control device. In other words, the availability of stored operating information in the camera system can also be changed after it has been produced by virtue of further operating specifications becoming available and/or in that previously available operating specifications are made unavailable or are blocked. A key or a license may be required to change the authorization information, wherein the authorization information or the available operating specifications can be permanently or temporarily activated, depending on the type of key or type of license.

The camera images for the at least one driver assistance function can only be generated on the basis of at least one operating specification of the multiple operating specifications, which operating instruction is described as currently available. In this way, it is possible to stipulate, by means of the authorization information, on the basis of which operating specifications camera images can be generated by the at least one camera of the camera device.

A solution according to an aspect of the invention advantageously makes it possible to configure the functionality of a camera device in a customizable manner. As a result of the mobility of the image sensor with the aid of the actuator, it is advantageously possible to adapt or individually and/or temporarily configure not only a driver assistance function itself but also an underlying image capture using at least one camera of the vehicle. In this way, it is advantageously possible to create a scalable camera device, the scalability of which requires no replacement of hardware components. In other words, the range of functions and/or performance of the camera image generation can be adapted and changed by the software using the camera device. A user of the vehicle can thus activate different functions and/or different functional scopes as required, without having to commit to a specific scope already when purchasing the vehicle. Furthermore, it is advantageously possible for camera devices with different functional scopes to be manufactured in the same way or with identical components, whereby production expenditure can be reduced in the case of different variants to be realized.

According to an aspect of the invention, provision can be made for the control device to have a communication interface, wherein the authorization information can be changed via the communication interface and/or one or more operating specifications can be changed and/or additionally stored in the control device via the communication interface. The change to the authorization information can comprise, in particular, a change as to which of the stored operating specifications are available and which are not. In addition or as an alternative to this, further operating specifications can also be added or already existing operating specifications can be changed or removed via the communication interface. Changes to the authorization information and/or to the operating specifications can be made, for example, by a user via an app store and/or by a service company or a workshop.

In one preferred embodiment of the invention, it can be provided that the operating specifications at least partially comprise at least one instruction for an evaluation and/or processing of the at least one camera image by the control device. In addition to the type of image capture by means of the image sensor that can be moved by means of the actuator, the operating specifications may also contain an evaluation of image data generated by the image sensor, in particular if the type of image capture set by means of the actuator requires or permits processing that differs from normal use of the image data generated by means of the image sensor. Additionally or alternatively, the operating specifications can specify how the camera image is to be edited, for example for a representation on a display device of the vehicle and/or for processing by the driver assistance function.

According to an aspect of the invention, it can be provided that the operating specifications in each case comprise at least one translational movement of the image sensor along an optical axis of the at least one camera and/or in at least one direction orthogonal to the optical axis of the camera, in particular in an image plane of the camera, and/or that the operating specifications each include at least one rotational movement of the image sensor about an axis of rotation parallel to the optical axis of the camera and/or around an axis of rotation orthogonal to the optical axis of the camera, in particular around an axis of rotation extending in the image plane of the camera. The operating specifications may comprise a single movement or a combination of several identical and/or different movements of the image sensor. The movement or the movements of the image sensor may take place before or while recording a camera image or before or during the recording of image information or partial images used for creating a camera image.

In a preferred configuration of the invention, there may be provision that at least some of the operating specifications comprise a movement of the image sensor before a plurality of generations of camera images by means of a stationary image sensor, one or more movements of the image sensor between the generations of individual camera images and/or one or more movements of the image sensor during the generation of an individual camera image. As will be described in more detail below, a movement of the image sensor before the recording of a plurality of camera images allows for example an offset or a misalignment between the image sensor and the lens arrangement to be compensated.

In particular, the recording properties of the camera, which result from the geometric relationship between the lens arrangement and the image sensor, can be influenced by means of one or more movements of the image sensor between the recordings of individual camera images. This makes it possible to advantageously record camera images with two or more different recording properties of the camera, which can improve, for example, environment detection within the scope of the driver assistance function implemented on the basis of the camera images.

By moving the image sensor while recording a camera image, it is possible, for example, to obtain a camera image composed of multiple partial images generated at different arrangement positions of the image sensor. This makes it possible, for example, for the recording area to be enlarged by a movement of the image sensor between two or more arrangement positions in the image plane, and/or for different spectral ranges and/or different distance ranges or object distances to be recorded sharply by means of a movement of the image sensor along the optical axis.

According to an aspect of the invention, provision can be made that at least one of the operating specifications is an operating specification for correcting aging effects, which is configured to set a position of the image sensor along the optical axis and/or in the image plane in dependence on aging information assigned to the at least one camera. In this case, the movement of the image sensor takes place in particular once before a plurality of camera images are recorded. Age-related effects, for example age-related misalignment between the image sensor and the lens arrangement and/or aging effects of the lens arrangement and/or of the image sensor, can be compensated for by the movement of the image sensor in dependence on the aging information.

The aging information can specify, for example, an operating period and/or an age of the at least one camera of the camera device and can be stored, for example, in the control device. Additionally or alternatively, the aging information may also be produced by one or more measurements of the value of a recording parameter in one or more arrangement positions of the image sensor. The one or more measured values of the recording parameter may in this case be compared with one or more reference values, wherein one of the image sensors is moved to a compensation position determined on the basis of a deviation between the at least one measured value and the at least one reference value.

Additionally or alternatively, according to an aspect of the invention it may be provided that at least one of the operating specifications is an operating specification for correcting temperature influences, which is configured to set a position of the image sensor along the optical axis as a function of temperature information describing a current environment temperature of the vehicle. The temperature information may be, for example, a temperature measurement value determined using a temperature sensor of the vehicle or transmitted to the vehicle via a communication connection. Temperature influences can be corrected for example upon starting of the vehicle and/or in the event of a temperature change between a current temperature and a temperature assigned to a previous setting of the image sensor exceeding a limit value.

According to an aspect of the invention, provision can be made for at least one of the operating specifications to be an operating specification for correcting a roll angle offset of the image sensor, which is configured to move based on orientation information describing a current orientation of the image sensor relative to a base surface on which the vehicle is located via the actuator in such a way that at least one line of a detector pixel array of the image sensor is positioned horizontally or is aligned approximately horizontally.

In this case, the movement of the image sensor can take place before a plurality of camera images are recorded, as a result of which an offset between the image sensor and the lens arrangement can be corrected, in particular permanently. Additionally or alternatively, the roll angle offset can also be corrected in dependence on inclination information of the vehicle, which describes an inclination of the vehicle about a vehicle longitudinal axis or a roll angle of the vehicle. Here, the inclination information may be determined for example by an inclination sensor of the vehicle and transmitted to the control device of the camera device.

In a further embodiment, according to the invention there can be provision that at least one of the operating specifications is an operating specification for reducing and/or compensating imaging aberrations of an optical element arranged in front of the at least one camera, wherein the operating specification is configured to ascertain a first value of an imaging parameter on the basis of an image recorded with the at least one camera using the image sensor in a first arrangement position wherein the image sensor can then be moved, depending on the first value, by the actuator into a second arrangement position which is assigned to a second, optimized value of the imaging parameter.

The optical element can be, in particular, a transparent or at least partially transparent component which is arranged in front of the lens arrangement of the camera, for example a vehicle pane such as a windshield, a cover or a section of the body or mounting part section. The image can be, for example, a recording of vehicle environment, or it can be a recording of a test target, in particular a target, as is often used for the calibration of camera systems. The second arrangement position, which can also be referred to as the camera target position, is determined and maintained for example once, or is determined continuously in an iterative process, and continuously approached by the actuator in an iterative process.

The movement of the image sensor in accordance with the operating specifications for reducing and/or compensating imaging aberrations of the optical element arranged in front of the at least one camera can be carried out during ongoing driving operation of the vehicle or within the scope of a repair, for example when replacing a windshield. In particular, the reduction and/or compensation of imaging aberrations can be performed whenever a relative positioning of the at least one camera relative to the optical element has changed.

The optimum second arrangement position or the actuator target position associated with this camera target position can be ascertained continuously or at predefinable times, in particular periodically, i.e., continuous optimization can be performed. However, it is also possible to carry out the reduction and/or compensation once and/or to ascertain an optimum camera and actuator target position respectively for different constellations, wherein the respective camera and actuator target positions can be stored for example in the control device and accordingly retrieved as required.

In a preferred embodiment of the invention, it may be provided that at least one of the operating specifications is an operating specification for improving an imaging quality of objects on the image sensor, wherein the operating specification is configured to set the position of the image sensor on the optical axis as a function of a current vehicle speed, in dependence on vehicle environment information at least partially describing the current vehicle environment and/or to change it continuously between at least two arrangement positions.

The operating specification for improving the imaging quality allows the position of the actuator on the optical axis to be set as a function of a current vehicle speed. As a result, depending on the vehicle speed, it is possible to select the object distance for which the best imaging quality is achieved in the image plane or on the image sensor of the camera. This makes it possible to counter the effect that, in particular, lenses with a large aperture have only a shallow depth of field, which greatly limits perfect imaging of objects at different distances from the vehicle. For driver assistance systems supporting the driving operation of a vehicle or for a driver of the vehicle, a relevant distance of objects for the current driving operation may differ at different vehicle speeds. By way of example, objects which are located close to the vehicle may be more relevant when driving at a low speed, whereas objects which are further away from the vehicle may be relevant, in particular, when driving at a high speed. The vehicle speed can be determined, for example, by a speed sensor of the vehicle and transmitted to the control device.

The environment information may in this case describe for example the color of at least one object and/or of a section of environment in an environment of the vehicle, wherein the selected position of the image sensor on the optical axis corresponds to the focus point on the optical axis that is assigned to the color.

Additionally or alternatively, the environment information can describe an environment brightness of at least part of the vehicle environment, wherein, for an ambient brightness below a brightness limit, an image sensor position corresponding to a focal point of a larger wavelength is selected than for an ambient brightness above the brightness limit value or above a further brightness limit value, and/or wherein the position of the image sensor is displaced to focal points of increasing wavelengths. In this way, with the aid of the operating specifications for improving an image quality in poorer lighting conditions, a better representation of the environment can be effected on the basis of longer-wave light or infrared light.

Additionally or alternatively, the position of the image sensor can also be changed continuously, in particular periodically, between at least two arrangement positions by the operating specification to improve an image quality on the optical axis. Continuously changing the position of the image sensor along the optical axis makes it possible to record camera images optimized for different parts of the electromagnetic spectrum over time, so that overall improved image data can be obtained by means of the camera, which include in particular objects in the environment of the vehicle that are represented sharply for different spectral regions. In other words, it is possible, for example by computing camera images recorded with differently positioned image sensors, to obtain image data that can have an improved depth of field overall. Additionally or alternatively, sharp images from different focus positions or wavelength ranges can be overlaid in order to generate an image or image information with an increased information content. By way of example, an image recorded in the visible spectrum and an image recorded in the infrared spectrum can be overlaid and/or at least partially supplemented by the respective other image.

According to an aspect of the invention, at least one of the operating specifications can be an operating specification for the situation-dependent setting of a camera field of view, wherein the lens arrangement maps, in an image plane of the camera, a projection image onto a recording surface of the image sensor, which projection image is larger than the recording area in at least one direction, wherein the operating specifications are configured to, in dependence on a vehicle status information describing the current state of the vehicle and/or on a vehicle environment information at least partially describing the current vehicle environment, to ascertain a target position for the image sensor in the image plane, and to move the image sensor by means of the actuator to the target position in the event of a deviation between a current sensor position in the image plane and the target position.

Within the scope of the operating specification for the situation-dependent setting of a camera field of view, the position of the image sensor in the image plane is selected as a function of the current vehicle operation or in dependence on the current vehicle environment. This advantageously also permits the proportion of the vehicle environment that is depicted on the camera images to be able to be adapted to the current vehicle operation or the current vehicle environment. Consequently, a part of the projection image which is projected next to the recording surface of the image sensor at an initial position of the image sensor, for example a position of the image sensor centered in relation to the projection image and/or with respect to the optical axis, is thus also advantageously made detectable by way of the camera. This makes it possible for a larger part of the vehicle environment to be taken into account for functions based on the camera images. Compared with an image sensor that is not movable relative to the lens arrangement, this results in the advantage that a greater part of the vehicle environment can be captured.

The projection image can be larger than the recording surface of the image sensor, at least in the vehicle transverse direction, wherein a currently set steering angle of the vehicle, which is measured for example by a steering angle sensor of the vehicle, is used as driving state information. In this case, the target position can be chosen in such a way that, in the target position, an additional part of the vehicle environment lying in the selected direction of travel is imaged onto the receiving surface. A projection image which is larger than the image sensor at least in the vehicle transverse direction contains image information from the vehicle environment laterally next to the vehicle that cannot be captured by the image sensor. In particular, this can affect both sides of the vehicle, that is to say the vehicle environment to the left and right of the vehicle in the direction of travel.

The target position for the image sensor can then be selected on the basis of the vehicle state information describing the currently set steering angle of the vehicle in such a manner that a part of the vehicle environment which lies in the set direction of travel and is not mapped on the recording surface at the current sensor position is imaged on the recording surface when an image sensor is located in the target position. In other words, proceeding from a current sensor position, the target position is such that a proportion of the projection image which lies in the chosen direction of travel and has not yet been imaged on the recording surface of the image sensor, is now, at the target position, projected onto the recording surface and can therefore be detected by the camera. This advantageously makes it possible to adapt the camera images captured by the camera to a current direction of travel or a chosen direction of travel. The adjustment of the position of the image sensor in the image plane can be carried out here both in the case of a moving vehicle and in the case of a stationary vehicle.

It is also possible that the projection image is larger than the recording area of the image sensor, at least in the vehicle vertical direction, wherein a current speed of the vehicle is used as the driving state information, wherein continuously, in the case of a decreasing speed of the vehicle or in the event of a speed of the vehicle undershooting a predefined limit value, the target position is selected in such a way that, at the target position, an additional part of the vehicle environment is depicted on the recording surface.

This makes it possible that, at low vehicle speeds, or even when the vehicle is stationary, an additional part of the vehicle environment above the vehicle which cannot be recorded in a current sensor position can be detected. As a result, for example, elements of the traffic infrastructure arranged above the vehicle, such as signs, traffic lights or the like, can be imaged to a greater extent or completely.

According to an aspect of the invention, provision can be made that at least one of the operating specifications is an operating specification for generating a camera image with an increased information content, wherein the image sensor has a plurality of pixels and a filter device, and wherein different filters are assigned to individual pixels by the filter device, wherein to generate a camera image comprising one or more image points, the image sensor by means of the actuator is moved relative to the lens arrangement between at least a first arrangement position and a second arrangement position, wherein, for at least one image point of the camera image in each of the at least two arrangement positions, at least one image information filtered using an identical filter or using a different filter is received via a pixel of the image sensor, wherein the camera image for the at least one image point comprises the at least two items of image information and/or a variable derived from the at least two items of image information.

The operating specifications for generating a camera image with an increased information content allow, for example, in the case of a defective pixel of the image sensor to measure the missing image information with another functional pixel, so that complete image information can be obtained for a camera image. Alternatively, in the second arrangement position, for at least some of the image points of the camera image, a different pixel of the image sensor to which a different type of optical filter of the filter device is assigned can be used. In this way, a second item of image information, which was generated by means of a different optical filter than the first item of image information in the first arrangement position, can be ascertained for the image point of the camera image. This advantageously allows that not only image information filtered by means of an optical filter is ascertained for individual image points of the camera image, but that image information generated by means of at least one further, different type of optical filter can be obtained in each case for these image points. It is possible that after the second arrangement position, one or more further arrangement positions are also approached, about which further image information can be ascertained. A camera image with an increased information content can be generated by recording multiple items of image information for the part of the projection image of the lens arrangement that is accounted for by one pixel.

An aspect of the invention furthermore relates to a vehicle with a camera device according to an aspect of the invention. All the advantages and configurations described above in relation to the camera device according to an aspect of the invention also apply analogously to the vehicle according to an aspect of the invention, and vice versa.

Furthermore, an aspect of the invention relates to a method for operating a camera device of a vehicle, comprising at least one camera and a control device, wherein the at least one camera is connected to the control device and has an image sensor, a lens arrangement comprising at least one lens, and at least one actuator by means of which the image sensor can be moved relative to the lens arrangement, wherein camera images generated with the at least one camera are used for the purpose of providing at least one driver assistance function of the vehicle, wherein one or more operating specifications for operating the at least one camera and authorization information are stored in the control device, wherein the operating specifications each contain different actuation of the image sensor by means of the at least one actuator before and/or during the generation of a camera image by the at least one camera, and the authorization information for at least part of the operating instructions indicates whether these are each available for generating a camera image for providing the at least one driver assistance function, wherein the camera images for the at least one driver assistance function are generated on the basis of at least one available operating specification of the multiple operating specifications.

All the advantages and configurations described above in relation to the camera device and the vehicle according to an aspect of the invention also apply analogously to the method according to an aspect of the invention, and vice versa.

### BRIEF DESCRIPTION OF THE DRAWINGS

Further advantages and embodiments will be apparent from the exemplary embodiments described in the following, and based on the figures. These figures are schematic representations and in particular:

FIG. 1 shows an exemplary embodiment of a vehicle according to the invention with a camera device according to an aspect of the invention,

FIG. 2 shows an exemplary embodiment of a camera of the camera device according to the invention in a side view,

FIG. 3 shows an exemplary embodiment of a camera of the camera device according to the invention in a plan view of an image sensor of the camera, and

FIG. 4 shows a schematic illustration of the camera device according to an aspect of he invention for explaining one exemplary embodiment of a method according to the invention.

### DETAILED DESCRIPTION OF EXEMPLARY EMBODIMENTS

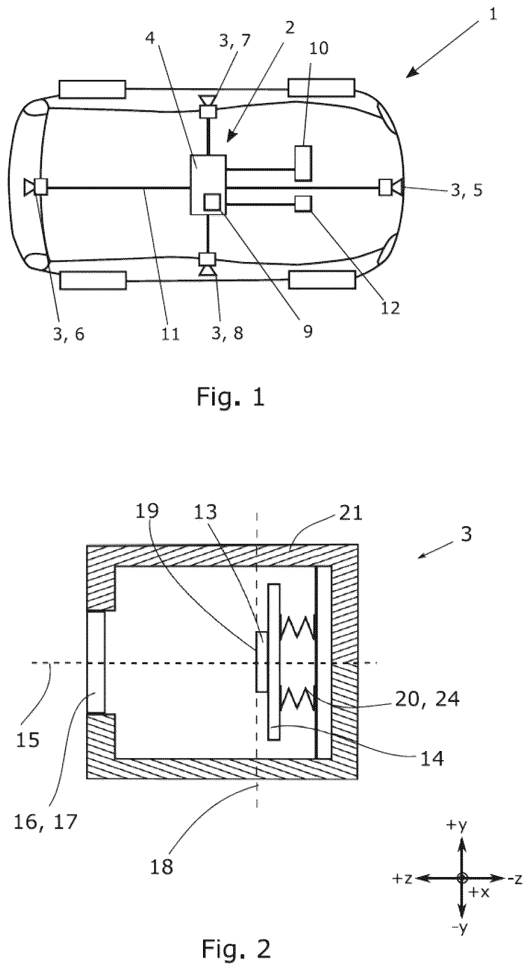

FIG. 1 shows an exemplary embodiment of a vehicle 1. The vehicle 1 may be, for example, a motor vehicle, in particular a passenger car, a truck or some other type of commercial vehicle. It is also possible for the vehicle 1 to be an unmotorized vehicle, such as a trailer, or for it to be a combination of a towing vehicle and a trailer. The vehicle 1 may also be a rail-bound vehicle, such as a tram or the like, or a robot.

The vehicle 1 comprises an exemplary embodiment of a camera device 2 which has one or more cameras 3 and a control device 4. In the present exemplary embodiment, the vehicle 1 comprises four cameras 3, which form a camera arrangement embodied as a surround-view system. A first camera 5 is arranged as a front camera of the vehicle 1, a second camera 6 is arranged as a rear camera of the vehicle 1, and a third camera 7 and a fourth camera 8 are each arranged as a side camera of the vehicle 1. The number and arrangement of the cameras 3 is an example here. The camera device 2 may also comprise a different number and/or cameras 3 arranged at other locations on the vehicle 1.

The control device 4 may be in the form of a microcontroller, a processor or another type of computing device, for example. The control device 4 comprises a memory device 9 in which data can be stored and/or in which one or more calculation specifications or algorithms can be implemented, which can implement, for example, one or more functions, in particular driver assistance functions, for the vehicle 1 by evaluating the camera images of the cameras 3. The control device 4 is configured for carrying out a method for operating at least one of the cameras 3 of the vehicle 1, wherein the control device 4 and the at least one camera 3 form a camera device 2 according to an aspect of the invention.

The vehicle 1 additionally comprises a display device 10 via which graphical information for a driver or a user of the vehicle 1 can be presented. The display device 10 may be, for example, one or more screens or displays or the like arranged in an interior of the vehicle 1.

The cameras 3 can be used in each case to generate image data from a partial region of environment of the vehicle 1. The cameras 3 are connected to the control device 4 via a communication connection 11. The communication connection 11 can comprise, for example, a plurality of point-to-point connections or be a bus connection such as a CAN bus or the like. Camera images or image data are transmitted from the cameras 3 to the control device 4, in particular continuously, via the communication connection 11. At least some of the camera images and/or a view of the environment generated from a plurality of camera images can then be reproduced on the display device 10 for a driver of the vehicle 1.

Furthermore, the vehicle 1 comprises a sensor device 12, which can comprise one or more sensors. The sensor device 12 comprises, in particular, a temperature sensor for generating temperature information describing a current environment temperature of the vehicle 1, a position sensor which can measure an item of orientation information describing an inclination of the vehicle 1 along its longitudinal axis, a speed sensor for determining a vehicle speed describing a current driving speed of the vehicle 1, an environment sensor for determining a vehicle environment information at least partially describing the current vehicle environment, and/or a steering angle sensor measuring a steering angle of the vehicle 1.

FIG. 2 shows a side view of a camera 3 of the vehicle 1. The camera 3 comprises an image sensor 13 for recording camera images, which image sensor is arranged, for example, on a printed circuit board 14. Furthermore, the camera 3 comprises a lens arrangement 17 that is arranged offset with respect to the image sensor 13 along an optical axis 15 of the camera 3 extending in the z direction and comprises at least one lens 16. By way of the lens arrangement 17, an image of the section of the vehicle environment recorded by the camera 3 is projected into an image plane 18, which, in the present case, extends in the x-direction and y-direction, of the camera 3.

The image sensor 13 has a recording surface 19, which is, for example, an array of photosensitive image dots or pixels, and which, in the present case, is likewise located in the image plane 18. The pixels can be arranged in rows and columns, for example, as a rectangular array. The image sensor 13 may be, for example, a semiconductor image sensor (CMOS image sensor). The image sensor 13 can be used to receive, in particular, light or electromagnetic radiation in the visible spectral range and possibly also in the infrared spectral range from a partial region of the vehicle environment. The image sensor 13 can be connected, for example, to further electrical components of the camera 3 and/or to the printed circuit board 14 via one or more flexible electrical connections, such as lines, spring contacts, bonding wires or the like.

The camera 3 furthermore comprises an actuator 20, by way of which the image sensor 13 can be moved relative to the lens arrangement 17 into different arrangement positions along the optical axis 15. The image sensor 14 may be fastened to the printed circuit board 14, for example, via the actuator 20, wherein the printed circuit board 14 for its part is arranged in a stationary manner on a supporting structure 21 of the camera 3, such as a camera housing or the like, so that the image sensor 13 is also movable relative to the supporting structure 21. Correspondingly, the lens arrangement 17 can also be attached to the supporting structure 21 and/or a structure connected thereto, as a result of which the image sensor 13 is also movable relative to the lens arrangement 14.

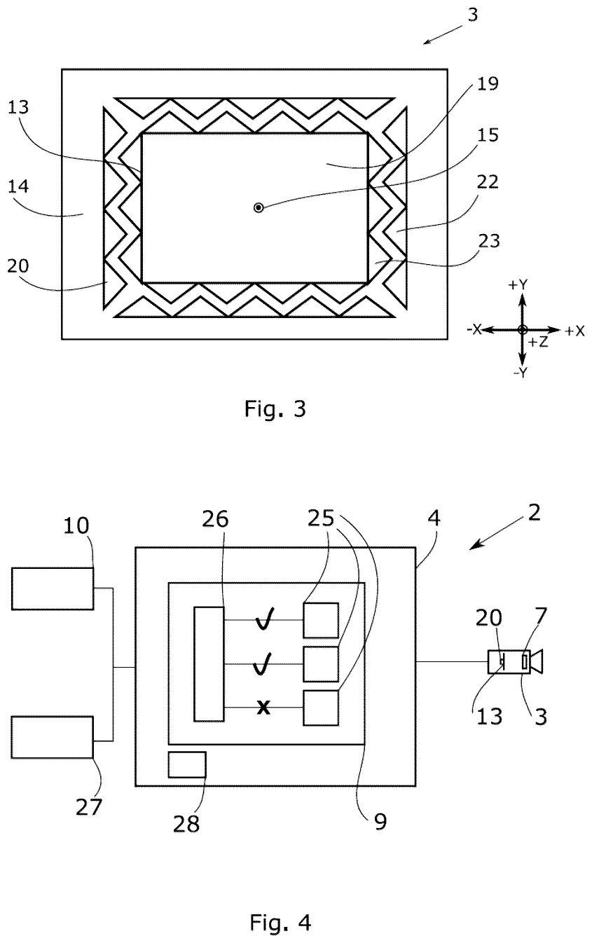

FIG. 3 shows a plan view of the image sensor 13 of the camera 3, the recording area 19 of which extends in the x direction and y direction, or in an xy plane, and thus in the image plane or parallel thereto. In this case, the optical axis 15 of the camera 3 runs orthogonally to the recording surface 19 in the z direction.

In FIGS. 2 and 3, the image sensor 13 is located, for example, in a first relative position or arrangement position relative to the supporting structure 21. The actuator 20 makes it possible to move the image sensor 13 relative to the supporting structure 14 along one or more degrees of freedom. Depending on the configuration of the actuator 20, the degrees of freedom may be translational degrees of freedom, which allow a displacement of the image sensor 13 in the x direction, y direction and/or z direction. Additionally or alternatively, the actuator 15 can also permit a rotational movement, i.e., a rotation of the image sensor 13, about the x-axis, the y-axis and/or the z-axis. Combined movements of a translational movement in the direction of one or more of the axes and/or of a rotational movement about one or more of the axes are also possible.

In the present exemplary embodiment, the actuator 20 is embodied as a MEMS actuator which, as is shown in FIG. 3, comprises a stationary first part 22, which is fastened to the printed circuit board 14, and a second part 23, which is movable relative to the first part 22 and is fastened to the image sensor 13. For example, by virtue of one or more electrical voltages being applied to the stationary first part 22 of the actuator 20, the relative position of the second part 23 of the actuator 20, and consequently also of the image sensor 13, in the image plane 18 can be changed or set. Analogously, it is also possible by means of at least one third part 24 of the actuator 20, which is illustrated in FIG. 2, to adjust the actuator in the z direction and thus along the optical axis 15. The configuration of the actuator 20 illustrated in FIGS. 2 and 3 is purely exemplary, it is possible, in principle, to use one or more different actuator shapes or actuator types, which can generate the translational and/or rotational movements of the image sensor 13 relative to the lens arrangement 17, which are required for the respective operating specifications.

FIG. 4 shows a schematic illustration of the camera device 2. One or more operating specifications 25 for operating the at least one camera 3 and authorization information 26 are stored in the control device 4 of the camera device 2. The operating specifications 25 each contain different actuation of the image sensor 13 by means of the at least one actuator 20 before and/or during the generation of at least one camera image by the at least one camera 3. The authorization information 26 describes, for at least some of the operating specifications 25, whether or not each of these are currently available for generating a camera image for providing the at least one driver assistance function, wherein the camera images for the at least one driver assistance function can only be generated on the basis of at least one operating rule 25 of the multiple operating specifications 25 described as currently available. In the present case, an availability of an operating specification 25 is symbolized by the check mark and an unavailability is symbolized by the X.

The driver assistance function, which uses the camera images of one or more of the cameras 3 of the vehicle 1, can represent the camera images or images derived therefrom, for example, on the display device 10 of the vehicle. It is possible that, in addition to the camera images, further graphic information, for example as text or as a graphic overlay, is added to the camera images. Such graphical information can be generated at least in part as a function of an evaluation of an image content of one or more camera images, for example by the control device 4 and/or by a further control device implementing a driver assistance function.

In addition to or as an alternative to the representation of the camera images, the control device 4 can determine information relating to the environment of the vehicle 1 by evaluating the image content of the camera images from one or more of the cameras 3 and can take this information as a basis for implementing, for example, an autonomous or semiautonomous driving function as a driver assistance function. For this purpose, the control device 4 can at least partially achieve transverse control and/or longitudinal control of the vehicle 1, for example, or perform actuation of one or more vehicle actuators 27, such as longitudinal guidance actuators and/or transverse guidance actuators, on the basis of the information about the vehicle environment obtained from the camera images.

The control device 4 also has a communication interface 28, wherein the authorization information 26 can be changed via the communication interface 28. Additionally or alternatively, one or more of the operating specifications 25 can also be changed, deleted or added to the memory unit 9 of the control device 4 via the communication interface 28. The communication interface 28 may be a communication interface for wired or wireless communication.

At least some of the operating specifications 25 stored in the control device 4 each comprise at least one instruction for evaluation and/or processing of the at least one camera image by the control device 4. By means of the control device 4, environment information at least partially describing the current environment of the vehicle 1 can be generated, for example, by evaluating the image content of one or more camera images. The evaluation can be carried out in particular on the basis of methods of artificial intelligence or computer vision, for example by means of semantic segmentation or the like. Additionally or alternatively, the operating specifications can specify how the camera image is to be edited, for example for a representation on a display device 10 of the vehicle 1 and/or for processing by the driver assistance function.

The operating specifications 25 each comprise at least one translational movement of the image sensor 13 along an optical axis 15 of the camera 3 and/or in at least one direction orthogonal to the optical axis 15 of the camera 3. Additionally or alternatively, the operating specifications 25 may also in each case include at least one rotational movement of the image sensor 13 about an axis of rotation in the z direction parallel to the optical axis 15 of the camera 3 and/or about an axis of rotation orthogonal to the optical axis 15, that is to say in the x direction or in the y direction.

At least some of the operating specifications 25 can include a movement of the image sensor 13 before a plurality of generations of the camera images using a stationary image sensor 13. This makes it possible, inter alia, to set a sensor position in order to compensate longer-term effects or effects which change only irregularly and/or comparatively slowly, for example a misalignment between the image sensor 13 and the lens arrangement 17, a temperature influence on the arrangement of the image sensor 13 relative to the lens arrangement 17, or the like. Also, settings of the sensor position which are dependent on a driving speed and/or a steering angle can be retained for a plurality of image recordings.

At least some of the operating specifications 25 may also include one or more movements of the image sensor 13 between the generations of individual camera images and/or one or more movements of the image sensor 13 during the generation of an individual camera image. This can be implemented, in particular, in order to achieve an improved image quality in a situation or in order to generate a camera image of a situation with an increased information content.

Specifically, provision can be made that at least one of the operating specifications 25 is an operating specification 25 for correcting aging effects, which is configured to set a position of the image sensor 13 along the optical axis 15 and/or in the image plane 18 in dependence on aging information assigned to the at least one camera.

Additionally or alternatively, it may be provided that at least one of the operating specifications 25 is an operating specification for correcting temperature influences, which sets a position of the image sensor 13 along the optical axis 15 as a function of temperature information describing a current environment temperature of the vehicle 1.

Another possibility is that at least one of the operating specifications 25 is an operating specification 25 for correcting a roll angle offset of the image sensor 13, which is designed to move the image sensor 13 via the actuator 20 in dependence on orientation information describing the current orientation of the image sensor 13 relative to a ground surface on which the vehicle 1 is located, in such a way that at least one line of a detector pixel array of the image sensor 13 is aligned horizontally or approximately horizontally.

At least one of the operating specifications 25 can be an operating specification 25 for reducing and/or compensating imaging aberrations of an optical element arranged in front of the at least one camera 3, for example a pane of the vehicle 1, which, on the basis of an image recorded with the at least one camera 3, with the image sensor 13 in a first arrangement position, determines a first value of an imaging parameter wherein the image sensor 13 is then moved, depending on the first value, by the actuator 20, into a second arrangement position, which is assigned to a second, optimized value of the imaging parameter.

Additionally or alternatively, at least one of the operating specifications 25 can be an operating specification for improving the quality of imaging of objects on the image sensor 13, wherein the operating specification sets the position of the image sensor 13 on the optical axis 15 as a function of a current vehicle speed of the vehicle 1, in dependence on an item of vehicle environment information at least partially describing the current vehicle environment, and/or varies continuously, in particular periodically, between at least two arrangement positions on the optical axis 15.

It is also possible for at least one of the operating specifications 25 to be an operating specification 25 for the situation-dependent setting of a camera field of view of the camera 3, wherein for this purpose, the lens arrangement 17 images onto the recording area 14 of the image sensor 13, in an image plane 18 of the camera 3, a projection image which is larger than the recording area 14 of the image sensor 13 in at least the x direction and/or the y direction. The operating specification 25 for the situation-dependent setting of the camera field of view ascertains a target position for the image sensor 13 in the image plane 18 on the basis of driving state information describing a current driving state of the vehicle 1 and/or vehicle environment information at least partially describing the current vehicle environment. If there is a deviation between a current sensor position in the image plane 18 and the target position, the image sensor 13 is then moved by means of the actuator 20 into the ascertained target position.

At least one of the operating specifications 25 can be an operating specification 25 for generating a camera image with an increased information content. For this purpose, the image sensor 13 has a plurality of pixels, which form the recording area 19 of the image sensor 13, and a filter device (not illustrated) which assigns different filters to individual pixels. In order to generate a camera image comprising one or more image points, the image sensor 13 is moved relative to the lens arrangement 17 between at least one first arrangement position and a second arrangement position by means of the actuator 20, wherein, for at least one image point of the camera image in each of the at least two arrangement positions, at least one item of image information is filtered via the same filter or via a different filter about a pixel of the image sensor 13, wherein the camera image for the at least one image point contains the at least two items of image information and/or a variable derived from the at least two items of image information.

The above-described operating specifications 25 may be stored in the control device 4 in any desired combination. Furthermore, these operating specifications 25 can be assigned an availability or unavailability in any desired manner by the authorization information 26. The driver assistance function can accordingly use the camera images that have been obtained by one or more of the operating specifications 25 marked as available.

1. A camera device for a vehicle comprising at least one camera and a control device connected to the camera, wherein the camera has an image sensor, a lens arrangement comprising at least one lens and at least one actuator by means of which the image sensor can be moved relative to the lens arrangement, and wherein camera images generated with the at least one camera can be used to provide at least one driver assistance function of the vehicle,
wherein
one or more operating specifications for operating the at least one camera and an item of authorization information are stored in the control device, wherein the operating specifications each contain different actuation of the image sensor by means of the at least one actuator before and/or during the generation of at least one camera image by the camera, and the authorization information for at least a part of the operating specifications describes whether these are each currently available for generating a camera image for providing the driver assistance function, wherein the camera images for the at least one driver assistance function can only be generated on the basis of at least one operating specification of the multiple operating specifications described as currently available.

2. The camera device according to claim 1,
wherein the control device has a communication interface, wherein the authorization information can be changed via the communication interface and/or one or more operating specifications can be changed via the communication interface and/or additionally stored in the control device.

3. The camera device according to claim 1, wherein the operating specifications at least partially comprise at least one instruction for an evaluation and/or processing of the at least one camera image by the control device.

4. The camera device according to claim 1,
wherein the operating specifications comprise at least one translational movement of the image sensor along an optical axis of the at least one camera and/or in at least one direction orthogonal to the optical axis of the camera and/or in that the operating specifications each comprise at least one rotational movement of the image sensor about a rotational axis parallel to the optical axis of the camera and/or around a rotational axis orthogonal to the optical axis of the camera.

5. The camera device according to claim 1,
wherein at least part of the operating specifications comprise movement of the image sensor prior to a plurality of camera image generations with a stationary image sensor, one or more movements of the image sensor between the generation of individual camera images, and/or one or more movements of the image sensor during the generation of a single camera image.

6. The camera device according to claim 1,
wherein at least one of the operating specifications is an operating specification for correcting aging effects, which is designed to adjust a position of the image sensor along the optical axis and/or in an image plane of the camera depending on aging information assigned to at least one camera.

7. The camera device according to claim 1,
wherein at least one of the operating specifications is an operating specification for correcting temperature influences, which is designed to adjust a position of the image sensor along the optical axis depending on temperature information describing the current environment temperature of the vehicle.

8. The camera device according to claim 1,
wherein at least one of the operating specifications is an operating specification for correcting a roll angle offset of the image sensor, which is designed to move via the actuator in dependence on orientation information describing the current orientation of the image sensor relative to a ground surface on which the vehicle located, in such a way that at least one line of a detector pixel array of the image sensor aligned horizontally or approximately horizontally.

9. The camera device according to claim 1,
wherein at least one of the operating specifications is an operating specification for reducing and/or compensating for imaging errors of an optical element arranged in front of the at least one camera which is designed to determine a first value of an imaging parameter using an image sensor in a first arrangement position on the basis of an image recorded by the at least one camera in a first arrangement position, wherein the image sensor can then be moved by means of the actuator in dependence on the first value into a second arrangement position, which is assigned to a second, optimized value of the imaging parameter.

10. The camera device according to claim 1,
wherein at least one of the operating specifications is an operating specification for improving the imaging quality of objects on the image sensor, wherein the operating specification is designed to adjust the position of the image sensor on the optical axis depending on the current vehicle speed, depending on vehicle environment information that at least partially describes the current vehicle environment, and/or to continuously change between at least two arrangement positions.

11. The camera device according to claim 1,
wherein at least one of the operating specifications is an operating specification for situation-dependent adjustment of a camera field of view, wherein the lens arrangement in an image plane of the camera images a projection image onto a recording surface of the image sensor, which is larger than the recording surface in at least one direction, wherein the operating specification is designed to ascertain a target position for the image sensor in the image plane, depending on driving status information describing a current driving status of the vehicle and/or vehicle environment information at least partially describing the current vehicle environment, and to move the image sensor (13) to the target position by means of the actuator in the event of a deviation between a current sensor position in the image plane and the target position.

12. The camera device according to claim 1,
wherein at least one of the operating specifications is an operating specification for generating a camera image with increased information content, wherein the image sensor has a plurality of pixels and a filter device, and wherein different filters are assigned to individual pixels by means of the filter device, wherein, in order to generate a camera image comprising one or more pixels, the image sensor moved via the actuator relative to the lens arrangement between at least a first arrangement position and a second arrangement position, wherein for at least one image point of the camera image in the at least two arrangement positions, at least one image information filtered via the same filter or via a different filter is received via a pixel of the image sensor, wherein the camera image for the at least one pixel contains the at least two items of image information and/or a quantity derived from the at least two items of image information.

13. A vehicle comprising a camera device according to claim 1.

14. A method for operating a camera device a vehicle comprising at least one camera and a control device wherein the at least one camera is connected to the control device and comprises an image sensor, a lens arrangement comprising at least one lens, and at least one actuator via which the image sensor can be moved relative to the lens arrangement, wherein camera images generated by the at least one camera are used to provide at least one driver assistance function of the vehicle,
wherein one or more operating specifications for operating the at least one camera and authorization information are stored in the control device, wherein the operating specifications each contain a different control of the image sensor via the at least one actuator before and/or during the generation of a camera image by the at least one camera, and the authorization information specifies for at least some of the operating specifications whether they are available for generating a camera image for providing the at least one driver assistance function, wherein the camera images for the at least one driver assistance function are generated on the basis of at least one available operating specification of the multiple operating specifications.

15. The camera device according to claim 2,
wherein the operating specifications at least partially comprise at least one instruction for an evaluation and/or processing of the at least one camera image by the control device.
